(19) United States
(12) Patent Application Publication
(10) Pub. No.: US 2011/0051418 A1
(43) Pub. Date: Mar. 3, 2011

(54) Method and Apparatus Pertaining to Heat Sinking a Light Fixture Light-Emitting Diode

(75) Inventor: Gregory L. Sibalich, Bowling Green, KY (US)

(73) Assignee: HEATHCO, LLC, Bowling Green, KY (US)

(21) Appl. No.: 12/546,935

(22) Filed: Aug. 25, 2009

(51) Int. Cl. F21S 4/00; H01J 9/24

(52) U.S. Cl. 362/249.02; 445/23; 362/373

(57) ABSTRACT

A wall-mounted light fixture comprises an LED-mounting surface having one or more LED's mounted thereon to serve as a primary source of illumination for the wall-mounted light fixture. This wall-mounted light fixture also generally comprises a house that contains the one or more LED's. This housing also comprises, on a side that is directly thermally coupled to the LED(s) and that is oriented towards and disposed closest to the aforementioned vertical wall (when the wall-mounted light fixture is properly mounted on the vertical wall), a heat sink. This heat sink is thermally coupled to the LED-mounting surface and has an exterior portion shaped to have a large surface area to thereby substantially increase a heat-exchange capacity of the heat sink.

### TECHNICAL FIELD

This invention relates generally to wall-mounted light fixtures and more particularly to wall-mounted light fixtures that use light-emitting diodes.

### BACKGROUND

Wall-mounted light fixtures of various kinds are known in the art. Such fixtures typically mount to a vertical wall (such as a building wall or a privacy, security, or cantilevered wall) and extend outwardly of the wall. One simple, ubiquitous example in these regards is the standard front-porch light found on many homes in the United States. Such fixtures often serve a variety of light purposes. This can include, for example, providing lighting for security purposes, aesthetic purposes, convenience and safety purposes, and so forth. Sometimes, a given light fixture serves more than one such purpose.

Traditionally, such wall-mounted light fixtures often employ incandescent light bulbs to serve as a primary source of illumination. Such light sources, however, are quite inefficient. Concerns in these regards have created interest in employing more efficient light sources in various application settings. For example, light-emitting diodes (LED's) are capable of providing light more efficiently than a typical incandescent light bulb.

Though more efficient, however, LED's do generate heat. This heat, in turn, can negatively impact the operation, output, and operating life of the LED when improperly managed. Physically managing excess heat generated by one or more LED's in a wall-mounted light fixture application setting, in turn, faces numerous challenges. Besides serious cost considerations, aesthetics play a significant part in limiting design options for wall-mounted light fixtures. Not only must the end result be visually pleasing in and of itself, the design must also look like a more-or-less typical wall-mounted light fixture. While significant aberrations in these regards may find some few fans, for the most part, the market demands a traditional appearance that admits of only small, rather than significant, changes to the form and function of the wall-mounted light fixture.

This, then, presents a conundrum for the designer; somehow providing a wall-mounted light fixture that can safely and effectively use LED's as a primary source of illumination while also achieving a solution that can readily accommodate use in the traditional form factor of standard wall-mounted light fixtures without unduly negatively impacting corresponding traditional aesthetics and functionality.

### BRIEF DESCRIPTION OF THE DRAWINGS

The above needs are at least partially met through provision of the method and apparatus pertaining to heat sinking a light-fixture light-emitting diode described in the following detailed description, particularly when studied in conjunction with the drawings, wherein:

FIG. 1 comprises a flow diagram as configured in accordance with various embodiments of the invention;

FIG. 2 comprises a perspective view as configured in accordance with various embodiments of the invention;

FIG. 3 comprises a perspective view as configured in accordance with various embodiments of the invention;

FIG. 4 comprises a perspective cutaway detail view as configured in accordance with various embodiments of the invention;

FIG. 5 comprises a side-elevational view as configured in accordance with various embodiments of the invention;

FIG. 6 comprises a rear-elevational view as configured in accordance with various embodiments of the invention;

FIG. 7 comprises a side-elevational view as configured in accordance with various embodiments of the invention;

FIG. 8 comprises a side-elevational view as configured in accordance with various embodiments of the invention; and

FIG. 9 comprises a bottom-plan cutaway detail view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments pertain to a wall-mounted light fixture configured to be mounted on a vertical wall. This wall-mounted light fixture comprises an LED-mounting surface having one or more LED's mounted thereon to serve as a primary source of illumination for the wall-mounted light fixture. This wall-mounted light fixture also generally comprises a housing that contains the one or more LED's. This housing also comprises, on a side that is directly thermally coupled to the LED(s) and that is oriented towards and disposed closest to the aforementioned vertical wall (when the wall-mounted light fixture is properly mounted on the vertical wall), a heat sink. This heat sink is thermally coupled to the LED-mounting surface and has an exterior portion shaped to have a large surface area to thereby substantially increase a heat-exchange capacity of the heat sink. So configured, this heat sink dissipates heat exuded by the LED(s) and thereby greatly aids in maintaining the efficient and reliable operation of the LED(s).

By one approach, this heat sink can comprise an integrally-formed component shaped, for example, with an L-shaped side profile. By another approach, this heat sink can comprise a physically separate component from the LED-mounting surface. So configured, the heat sink can be mechanically and thermally joined to the LED-mounting surface to provide the desired thermal pathway between the heat-generating LED(s) and the heat-dissipating heat sink.

As noted, the heat sink itself has a portion that is shaped to offer a large surface area to thereby increase the heat sink's heat-exchange capacity. By one approach this can comprise providing the heat sink with a plurality of fins. By another approach, alone or in combination with the foregoing, this can comprise providing the heat sink with a plurality of pins.

So configured, a rearward-facing panel of a typical four-panel wall-mounted light fixture can serve, in whole or in part, as the aforementioned heat sink. This, in turn, significantly preserves the traditional aesthetics of the resultant fixture. The remaining panels can comprise transparent panels in accord with traditional practice in these regards. That the rear panel is partially or wholly opaque (due to the presence of the heat sink) will largely pass without notice as a viewer will typically not stand between the fixture and the wall and hence will not be availed of a viewing angle that will readily reveal this condition. Further, the opaque nature of the rear panel as discerned from the front or the side is not particularly surprising due to the relative proximity of the wall and hence does not call undue attention to itself.

The presence of the heat sink, in turn, can greatly assist in effectively managing the heat exuded by the LED(s). This can lead to greater consistency of lighting levels during usage (even for extended periods of time). This can also lead to increased operating lifetimes for the LED(s). Those skilled in the art will also appreciate that the considerable heat-handling capabilities of such a heat sink permit a considerable number of powerful LED's to be employed in a given wall-mounted light fixture. This, in turn, permits the fixture to provide a considerable amount of resultant lighting suitable for any number of lighting purposes.

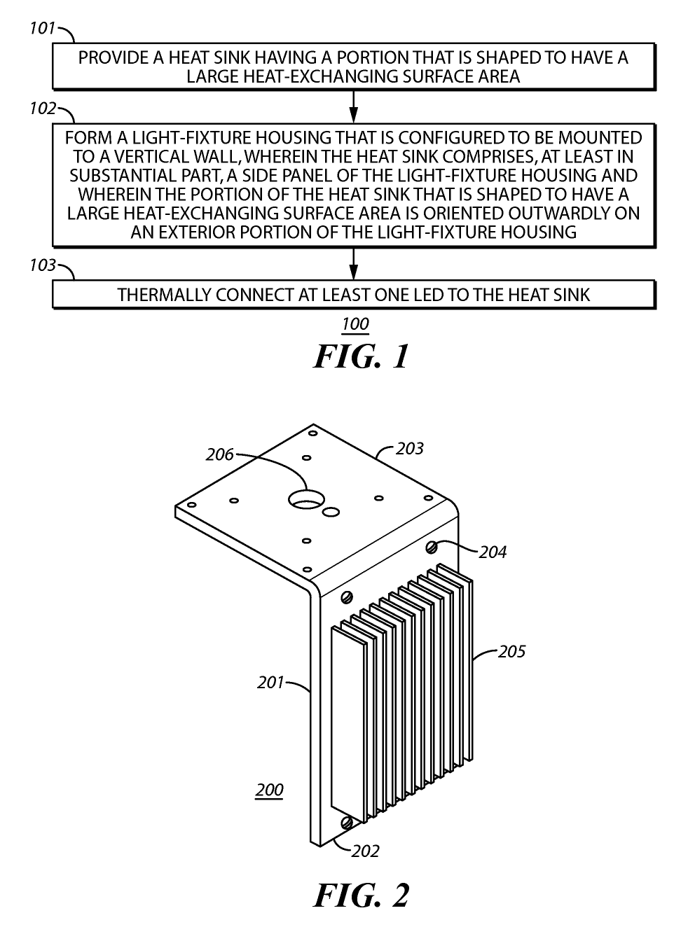

These and other benefits may become clearer upon making a thorough review and study of the following detailed description. Referring now to the drawings, and in particular to FIG. 1, an illustrative process 100 that is compatible with many of these teachings will now be presented.

This process 100 provides the step 101 of providing a heat sink having a portion that is shaped to have a large heat-exchanging surface area. By one approach, and referring momentarily to FIG. 2, this heat sink 200 can have an L-shaped profile 201 comprising a heat-exchange leg 202 and an LED-mounting surface 203. In this example the heat sink 200 has holes (for example, holes such as the one denoted by reference numeral 204) that facilitate securing the heat sink 200 in a corresponding light-fixture housing (not shown). These holes 204 can be threaded to receive a threaded securement member such as a bolt or screw (not shown). Further discussion in these regards appears further herein where appropriate.

In this example, the portion shaped to have a large heat-exchanging surface area comprises a plurality of heat-exchanging fins 205. These fins are substantially identical to one another and are disposed perpendicular to the heat-exchange leg 202 and substantially parallel to one another. This configuration provides an unobstructed air channel between adjacent fins 205. By one approach these fins 205 are configured such that, when the heat sink 200 is mounted in a wall-mounted light fixture, these fins 205 will be oriented at least substantially parallel to the vertical axis of the housing. The general design and operation of such a heat sink comprises a well-understood area of endeavor and requires no further elaboration here.

Also in this example the LED-mounting surface 203 has a hole 206 disposed there through to receive electrical wiring (not shown). This electrical wiring serves to deliver electricity to effect energization of the corresponding LED (not shown). By one approach, the LED would be mounted underneath the illustrated LED-mounting surface 203. In such a case the aforementioned electrical wiring would then extend upwardly (in this view) in order to connect to an electrical power source. Of course the power source may be conditioned from a generally available source (such as a mains supply) into a source more suitable to power the LED as is well known in the art.

In the described example the heat sink 200 comprises an integral structure. That is, the heat-exchange leg 202 and the LED-mounting surface 203 are physically one with one another and are not separable from one another absent the use of a destructive process such as cutting or breaking.

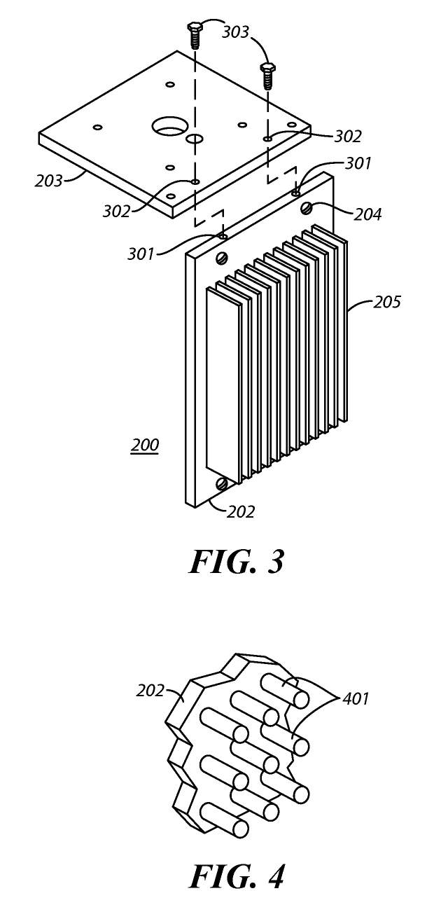

These teachings will readily accommodate other approaches in these regards, however. For example, and referring now momentarily to FIG. 3, the aforementioned heat-exchange leg 202 and the LED-mounting surface 203 can comprise separate structures (that is, physical discrete and non-integral components) that are thermally and mechanically connected to one another. In this illustrative example, the heat-exchange leg 202 has threaded holes 301 formed in an upper edge and the LED-mounting surface 203 has corresponding holes 302 formed there through in registration with the heat-exchange leg's holes 301. So configured, threaded attachment members 303 (such as screws, bolts, or the like) can be disposed and tightened within these holes 301 and 302 in order to secure the LED-mounting surface 203 to the heat-exchange leg 202 to thereby form the aforementioned thermal and mechanical connection.

As noted above, the heat sink 200 has a portion shaped to have a large heat-exchanging surface area. As used herein, this reference to a “large heat-exchanging surface area” will be understood to refer to a form factor that is specifically designed and intended to provide a greatly increased surface area over what would otherwise be afforded by the form factor envelope itself. This can be accomplished, for example, by the use of indentations, undulations, and other surface irregularities.

As noted above, by one approach this large heat-exchanging surface area can comprise a plurality of fins. With momentary reference now to FIG. 4 and as another illustrative example, this large heat-exchanging surface area can comprise (in lieu of fins or in combination therewith) a plurality of heat-exchanging pins 401. Such pins can be regularly and symmetrically positioned or can be fully or partially randomly positioned as desired. Those skilled in the art will recognize that other possibilities exist in these regards as well.

As noted, the heat sink 200 serves to absorb heat from an LED(s) mounted to the LED-mounting surface 203 and to dissipate that heat via the large heat-exchanging surface area. Those skilled in the art understand that some materials serve better in these regards than others. By one approach, for example, a portion or all of the heat sink 200 can comprise aluminum or a suitable aluminum alloy.

Referring now to FIGS. 1, 5, and 6, this process 100 also provides the step 102 of forming a light-fixture housing 500 that is configured to be mounted to a vertical wall 501 (such as, for example, the wall of a building such as a residence, office, retail facility, industrial facility, or the like) wherein the aforementioned heat sink 200 comprises (at least in substantial part) a side panel of the light-fixture housing 500. Such a light-fixture housing 500 will typically have a mounting fixture 502 that secures to the aforementioned wall 501 and an arm, hook, or other cantilevered component 503 that secures the light-fixture housing 500 to the mounting fixture 502 at some distance to the side of the wall 501. Also typically, the remaining panels 504 of the light-fixture housing 500 are at least substantially transparent (and most typically fully transparent) to thereby freely pass light from within the light-fixture housing 500 to the surrounding area.

In this particular illustrative example, the LED-mounting surface 203 is disposed upwardly in the light-fixture housing 501. So configured, the heat-exchange leg of the heat sink 200 forms the panel of the wall-mounted light fixture 500 that is oriented towards and disposed closest to the vertical wall 501 when the wall-mounted light fixture 500 is properly mounted on the vertical wall 501. As used herein, the expression “properly mounted” will be understood to refer to an installation of the wall-mounted light fixture 500 that accords with the intended design and configuration of the wall-mounted light fixture 500 (“intended,” that is, by the manufacturer and distributor of the fixture). For example, it would not comprise a proper mounting in this case to mount the light fixture 500 with its longitudinal axis perpendicular to the vertical wall 501; though perhaps physically possible, such a mounting scheme would run contrary to the intended design and configuration of this particular fixture.

So configured, that exterior portion of the heat sink having the large surface area to thereby substantially increase the heat-exchange capacity of the heat sink (i.e., in this illustrative example, the heat-exchange fins 205) is disposed towards the vertical wall 501. As shown in FIG. 6, the heat sink 200 can be affixed in place by using an attachment mechanism such as screws 601 that secure the heat-exchange leg 202 of the heat sink 200 to the frame of the wall-mounted light fixture 500. These screws 601 can be threadably engaged, for example, with the threaded holes 204 provided in the heat-exchange leg 202 as described above.

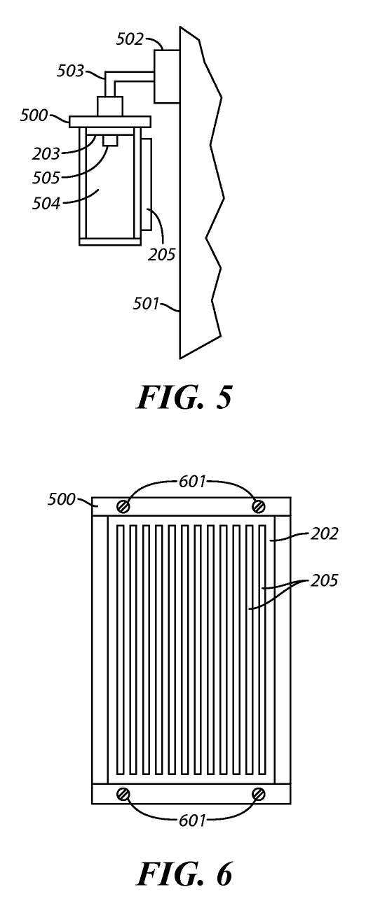

With continued reference to FIGS. 1 and 5, this process 100 further provides the step 103 of thermally connecting one or more LED's 505 to the heat sink 200. In particular, and as alluded to above, this can comprise thermally connecting the LED(s) 505 to the LED-mounting surface 203. This can comprise using screws or other bonding methodologies (such as thermally conductive adhesives, clamps, or the like) (not shown).

It will be understood that this LED 505 as is thermally coupled to this heat sink 200 serves as the primary source of illumination for this wall-mounted light fixture 500. That is, regardless of whether the primary purpose of the light fixture is to provide general ambient lighting, security lighting, safety lighting, or otherwise, this LED 505 provides the major component of the intensity of that lighting (that is, more than 50% of that lighting). When using more than one such LED 505 in this manner, the resultant plurality of LED's 505 collectively serve as the primary source of the fixture's illumination.

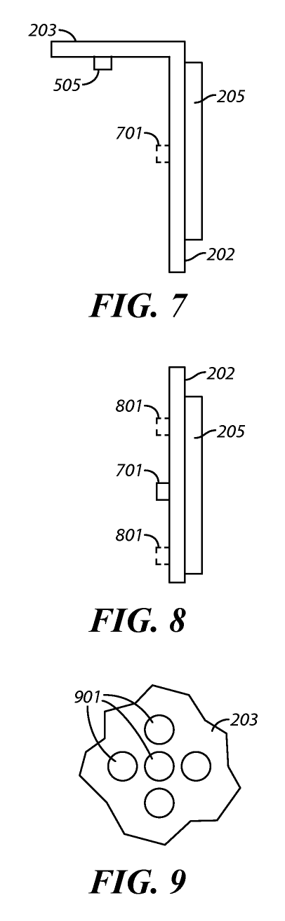

That said, those skilled in the art will appreciate that such LED's can be mounted in any number of positions with respect to the aforementioned large heat-exchanging surface area. As one illustration in these regards, and referring now to FIG. 7, while a first one (or more) LED 505 is mounted to an LED-mounting surface 203 as has already been described above, one or more additional LED's 701 can be optionally mounted directly opposite the large heat-exchanging surface area (in this example, the heat-exchange fins 205).

As another illustrative example in these regards, and referring now to FIG. 8, the aforementioned LED-mounting surface can reside on the opposite side of the large heat-exchanging surface area. In such a case, the LED 701 will only be mounted on a side that is opposite the large heat-exchanging surface area. Again, these teachings will readily accommodate optionally including additional such LED's 801 that mount above, or below, this first-mentioned LED 701 as desired.

As noted above, these teachings will readily accommodate using two or more LED's. As one further illustrative example in such regards, and referring now to FIG. 9, this can comprise mounting a cluster of LED's 901 to the LED-mounting surface 203. Such a cluster can comprise a plurality of physically discrete LED's or can comprise an integral multi-LED component as desired. Such a cluster can provide an increased quantity of light. Such a cluster will also produce an increased quantity of heat; those skilled in the art will recognize and appreciate that the teachings provided herein will effectively and efficiently serve to direct this heat towards the large heat-exchanging surface area where that heat can be readily dissipated into the ambient atmosphere.

When using a plurality of LED's, these teachings will readily accommodate using different LED's. The LED's may differ from one another, for example, with respect to their output lumens, their output directionality, their power requirements, the color of their light output, their size, their form factor, their mounting requirements, and so forth.

So configured, the rear panel of a wall-mounted light fixture comprises, in whole or in part, at least that portion of a heat sink as comprises a large heat-exchanging surface area. So disposed, this large heat-exchanging surface area is oriented towards the vertical wall upon which the light fixture is mounted and is therefore, for the most part, out of sight to the ordinary observer. Given the proximity of the light fixture to the wall, it is unlikely that an observer in ordinary course will attempt to view the light from the backside of the light fixture. From essentially all other points of view, the light exuded by the LED(s) will be transmitted through the partially or fully transparent panels of the light fixture such that the wall-mounted light fixture looks and functions, for all effective purposes, as an ordinary traditional wall-mounted light fixture in such regards.

Those skilled in the art will therefore appreciate and understand that these teachings permit one or more LED's to serve as the primary source of illumination for a wall-mounted light fixture without unduly compromising the traditional aesthetics associated with wall-mounted light fixtures or the quantity and nature of light that is otherwise functionally expected from such a fixture. These beneficial results are achieved in a cost-effective manner. It will further be appreciated that these results can be applied in conjunction with numerous existing designs for wall-mounted light fixtures and that these teachings hence serve to greatly leverage the existing capabilities and functionality of such platforms. It will also be appreciated that these teachings are highly scalable and can be employed with a variety of differently-sized light fixtures, form factors, and lighting output requirements.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, these teachings can be readily applied with a wall-mounted light fixture having more, or fewer, panels than four. As another example in these regards, the inside surface of the panel that comprises the heat sink can be partially or fully mirrored. Reflections from that mirrored surface, in turn, can assist in disguising the fact that this panel is, in fact, largely or fully opaque.

I claim:

1. A wall-mounted light fixture configured to be mounted on a vertical wall, comprising:
a light-emitting diode (LED)-mounting surface;
at least one LED that is mounted on the LED-mounting surface and that serves as a primary source of illumination;
a housing that contains the at least one LED, wherein the housing comprises, on a side that is directly thermally coupled to the at least one LED and that is oriented towards and disposed closest to the vertical wall when the wall-mounted light fixture is properly mounted on the vertical wall, a heat sink that is thermally coupled to the LED-mounting surface and that has an exterior portion shaped to have a large surface area to thereby substantially increase a heat-exchange capacity of the heat sink, such that the heat sink dissipates heat exuded by the at least one LED.

2. The wall-mounted light fixture of claim 1 wherein the at least one LED comprises a plurality of LED's that collectively serve as the primary source of illumination.

3. The wall-mounted light fixture of claim 1 wherein the at least one LED is mounted directly opposite the side.

4. The wall-mounted light fixture of claim 1 wherein the at least one LED is mounted on a portion of the heat sink that extends perpendicularly to the side.

5. The wall-mounted light fixture of claim 1 wherein the heat sink is comprised of aluminum.

6. The wall-mounted light fixture of claim 1 wherein the housing comprises a plurality of side panels and the heat sink comprises one of the plurality of side panels.

7. The wall-mounted light fixture of claim 6 wherein at least some of the plurality of side panels comprise at least substantially transparent panels.

8. The wall-mounted light fixture of claim 1 wherein the exterior portion that is shaped to have a large surface area comprises a plurality of fins.

9. The wall-mounted light fixture of claim 8 wherein the plurality of fins are oriented at least substantially parallel to a vertical axis of the housing.

10. The wall-mounted light fixture of claim 1 wherein the exterior portion that is shaped to have a large surface area comprises a plurality of pins.

11. The wall-mounted light fixture of claim 1 wherein the LED-mounting surface and the heat sink comprise an integral structure.

12. The wall-mounted light fixture of claim 1 wherein the LED-mounting surface and the heat sink comprise separate structures that are thermally and mechanically connected to one another.

13. A method comprising:
providing a heat sink having a portion that is shaped to have a large heat-exchanging surface area;
forming a light-fixture housing that is configured to be mounted to a vertical wall, wherein the heat sink comprises, at least in substantial part, a side panel of the light-fixture housing and wherein the portion of the heat sink that is shaped to have a large heat-exchanging surface area is oriented outwardly on an exterior portion of the light-fixture housing;
thermally connecting at least one light-emitting diode (LED) to the heat sink.

14. The method of claim 13 wherein thermally connecting the at least one LED to the heat sink comprises thermally connecting the at least one LED to the heat sink opposite the portion of the heat sink that is shaped to have the large heat-exchanging surface area.

15. The method of claim 13 wherein thermally connecting the at least one LED to the heat sink comprises thermally connecting the at least one LED to an integral portion of the heat sink that is perpendicular to the portion of the heat sink that is shaped to have the large heat-exchanging surface area.

16. The method of claim 15 wherein providing a heat sink comprises providing a heat sink having an L-shaped side profile.

17. The method of claim 13 wherein thermally connecting at least one LED to the heat sink comprises mounting the at least one LED to an LED-mounting surface that is physically discrete from the heat sink and thermally and mechanically connecting the LED-mounting surface to the heat sink.

18. The method of claim 13 wherein providing a heat sink having a portion that is shaped to have a large heat-exchanging surface area comprises providing a heat sink having a plurality of heat-exchanging fins.

19. The method of claim 18 wherein the plurality of heat-exchanging fins are oriented at least substantially parallel to a vertical axis of the light-fixture housing.

20. The method of claim 13 wherein providing a heat sink having a portion that is shaped to have a large heat-exchanging surface area comprises providing a heat sink having a plurality of heat-exchanging pins.
